(19) United States
(12) Patent Application Publication
(10) Pub. No.: US 2004/0131999 A1
(43) Pub. Date: Jul. 8, 2004

(54) Computer-based system for instruction using multi-modal teaching methods

(76) Inventor: Stephen J. Dresnick, Coral Gables, FL (US)

Correspondence Address: LOTT & FRIEDLAND, P.A., P.O. BOX 141098, CORAL GABLES, FL, 33114-1098, US

(21) Appl. No.: 10/337,249

(22) Filed: Jan. 6, 2003

(51) Int. Cl. G09B 3/00

(52) U.S. Cl. 434/350

(57) ABSTRACT

A computer-based remote instruction system is provided which utilizes a multi-modal teaching methodology permitting a student, among other things, to select a preferred teaching technique, to control the pace and depth of learning, and to switch among the available teaching techniques at any point during the course of instruction.

### TECHNICAL FIELD

The present invention relates generally to computer-based remote methods of instruction for use by teachers, students and education administrators, and in particular, to a computer-based remote instruction system which utilizes a multi-modal teaching methodology permitting a student, among other things, to select a preferred teaching technique, to control the pace and depth of learning, and to switch among the available teaching techniques at any point during the course of instruction.

### BACKGROUND OF THE INVENTION

Teaching methodologies have evolved and developed through centuries of human experience. Methodologies in use today have been ingrained into societies based on a number of factors, including, religious, political and scientific biases. Based on the different approaches taken by different cultures towards teaching, a large number of techniques and methodologies have emerged.

It is generally accepted among those skilled in the art of teaching that even amongst a population with homogeneous cultural, religious and socio-political backgrounds, different methodologies are more or less efficient with regard to particular students depending on the students' receptiveness and aptitude for learning using the chosen methodologies. Stated differently, if a student is taught using a methodology which the student prefers for objective or subjective reasons, the student will learn more, will retain more, and will do so quicker.

Although educators and administrators have known for decades that particular methodologies are better suited for certain types of students, the physical and financial restraints inherent in the traditional education setting have prevented the implementation of an educational system which provides true freedom for the student to select a preferred educational methodology.

A “traditional” teaching institution (i.e., a school or university) includes a physical building or set of buildings (i.e., a campus) which contains individual rooms (i.e., classrooms) where particular courses are taught. The traditional teaching model requires an instructor and all students of the course being taught to be physically present in the same classroom at the same time on a regular schedule. Generally, the teacher presents materials to the students using a methodology selected by the teacher or school administrators. Students are tested on the subject matter of the course at least once during the course and depending on the score attained by a student in such test or tests, the student is assigned a grade. A student is assigned a “passing” score when the instructor deems, using objective or subjective criteria (depending on the teaching methodology selected), that the student has sufficient command of the course materials.

The traditional setting is riddled with inherent limitations which make it difficult to offer coursework using a multiple-methodology, or “multi-modal”, curriculum. Specifically, a teacher in a traditional setting would have a very difficult time in physically administering a classroom in which each student uses a different teaching methodology or a combination of methodologies. A teacher would have to develop a sophisticated set of record-keeping standards just to be able to know what methodology or combinations of methodology each student is using, what progress each student is making and which students need additional support or counseling.

Moreover, a primary advantage in a multi-modal instruction system is that students are permitted, by selecting certain teaching methodologies and making other choices, to dictate the pace of learning which is most comfortable, and thus more efficient for them. In the traditional classroom environment, maintaining different learning tracks among a group of students is extremely difficult to implement without unduly taxing the resources available to the teacher. The effort required from a teacher in order to maintain multiple learning tracks within a single classroom is almost equivalent to that required to teach multiple classes.

Due to this limitation in a traditional teaching environment, teachers tend to utilize a “lowest common denominator” approach and teach the course materials at a pace which is most comfortable and efficient for a majority of the students in the class. As a result, certain students will fall behind the group and certain students will not be sufficiently challenged and may become disinterested. The end result may be a significant level of underachievement by a sizeable portion of the pupils in the classroom.

At best a traditional institution with sufficient resources and a large enough student population, may offer parallel courses teaching the same subject matter but using different teaching methodologies. In this sense, a student has some control over the teaching methodology at the time of enrollment. However, this type of solution adds significant expense and complexity to the administration of the institution's curriculum. In addition, the parallel course solution does not resolve the problems created by having to maintain the same pace of learning for the entire classroom.

Also, a student who changes his or her mind about the chosen teaching methodology cannot, due to the inherent limitations of a physical classroom, simply switch to a parallel course using an alternative teaching methodology. Often, the only recourse available to such a student is to continue with a course using an ill-suited methodology or to drop the course and take a parallel course later on in the learning circle. Both solutions are sub-optimal.

The advent of personal computers and the proliferation of ubiquitous networks, such as the Internet, which seamlessly connect such computers, has opened new avenues in virtually every aspect of teaching and learning. Computers and computer networks are no longer the exclusive domain of highly skilled and specialized individuals and have, in fact, become a mainstream tool. Computer technology has removed many of the barriers inherent in traditional educational environments and has opened the doors to new ways of teaching and learning. Although traditional “brick and mortar” schools are, and may continue to be, the predominant educational environment, computer based teaching technology is quickly becoming established in areas which cannot be efficiently served by traditional schools.

In fact, computer based instruction is considered by many skilled in the art to be superior to traditional education environments. A recent study conducted at Florida International University concluded that in an experimental setting, students who received online instruction had generally higher levels of achievement than students who were taught identical subject matter in a classroom setting. Comparing Web-Based and Classroom-Based Learning: A Quantitative Study, M. O. Thirunarayanan and Aixa Pérez-Prado, JOURNAL OF RESEARCH ON COMPUTING IN EDUCATION, Volume 34 Number 2 2001-2002.

Specifically with regard to the subject matter of the present invention, the ability (1) to easily and inexpensively connect a large number of personal computers at disparate geographic locations with a central computer, and (2) to incorporate large amounts of information inexpensively in commonly available computer media (like CD-ROMS) has made it feasible for the first time to create an instruction system which utilizes a multi-modal teaching methodology permitting students to select their preferred teaching technique, to control the pace and depth of learning, and to switch among the available teaching techniques at any point during the course of instruction.

Because of the high level of flexibility and automation permitted by the use of computers, online teachers and administrators can, for the first time, truly afford students the freedom of choice to learn in ways which are most efficient to them without being burdened with the inherent limitations of physical classrooms.

A review of the prior art reveals that a computer-based multi-modal instruction system has never been realized. Previous attempts at computer-based teaching methods are described in U.S. Pat. No. 6,411,796 to Remschel (the '796 patent); U.S. Pat. No. 6,393,253 to Kitabatake (the '253 patent); U.S. Pat. No. 6,347,943 to Fields et al. (the '943 patent); U.S. Pat. No. 6,074,216 to Cueto (the '216 patent); and U.S. Pat. No. 5,002,491 to Spiece (the '491 patent)

The '796 patent describes a learning which includes student units for use by students, a teacher unit for use by a teacher, and a number of master storage devices that store information reproduced by the student units. The system further includes a computer having a graphical user interface for use also by the teacher that operates to control each of the student units. The graphical user interface allows the computer to control all functions of the learning system, including the coupling of student and class data to specific interface/input devices, the assignment of students to various groups, and the synchronized control of the learning system hardware.

The '253 patent describes an educational data processing device to reutilize the answer data to a certain question as incorrect answer data for other questions and a data processing device to store question and answer data. The invention comprises a computer with a CPU, a memory system, and input and output systems; a data set group (“DSG”) stored in memory and consisting of multiple data sets (“DS”) where each DS consists of two types of data, a question and answer. Each DS also contains a program that performs the following functions: (a) selects a question and answer data from a DS, and one or more answer data from randomly selected DS in said DSG; (b) presents a question and multiple-choice answer set to the user; and (c) determines whether the answer inputted by the user through said input system is correct or not and notifies the user of the result through said output system.

The '943 patent describes an electronic performance support system for creating individualized courses of instruction to each user. An authoring mechanism is used to create at least one knowledge base relating to a particular topic. An assessment mechanism evaluates each user's knowledge on a particular topic and devises a course of instruction based on the assessed knowledgeability of each user. After interacting with the assessment mechanism, each user navigates through a corresponding, individualized course of instruction. Each individualized course of instruction includes data items selected from a learning mechanism and a research library. The system may include a communication medium through which users are able to communicate with each other.

The '216 patent describes an interactive education process that permits students at remote locations to provide feedback to an instructor in an ordered manner. Each student is provided with a network connection to an interactivity engine which includes a natural language interface. Responses to the feedback are provided through the interactivity engine to the student. In addition, the responses are ranked in accordance with the number of users logged on, and the number and nature of the questions or other feedback. If there are a significant number of questions or feedback on the same subject, the responses are grouped and are provided to a stage manager or the instructor for broadcast response. The inquiries and responses are published at an internet site and are accessible by all of the students.

The '491 patent describes an interactive electronic classroom system for enabling teachers to teach students concepts and to receive immediate feedback regarding how well the students have learned the concepts. The invention enables students to proceed in lockstep or at their own pace through exercises and quizzes, responding electronically to questions asked, the teacher being able to receive the responses, and to interpret a readout, in histogram or other graphic display form, of student responses. In a preferred embodiment, a central computer using an IBM AT (tm) compatible system is employed, together with a plurality of student computers which range from simple devices to full fledged personal computers. Optical peripheral hardware, such as VCRs or other recording/reproducing devices, may be used to provide lessons to students in association with the computer network.

None of the inventions disclosed in the prior art describe a computer-based remote instruction system which utilizes a multi-modal teaching methodology permitting a student, among other things, to select a preferred teaching technique, to control the pace and depth of learning, and to switch among the available teaching techniques at any point during the course of instruction.

Accordingly, there is a need in the prior art for a computer-based instruction system to permit students, teachers and administrators to easily and seamlessly utilize multiple modes of instruction to teach a particular subject.

For teachers and educational administrators, there is a need in the prior art for a system which permits the orderly and systematic management of multi-modal curricula.

There is a further need in the art to provide teachers and educational administrators with a system which permits the coherent authoring of teaching materials for use in a multi-modal teaching environment.

There is yet a further need in the art to provide teachers and educational administrators with a system which can measure the progress of a large number of student's each potentially using differing combinations of learning methodologies and learning pace.

For students, there is a need in the prior art for an instruction system which allows the selection of one, from amongst many, teaching methodologies, for learning a particular subject.

There is a further need in the art to provide students with a system which enables them, once they have begun learning, to switch with ease between the multiple teaching methodologies without requiring restarting of the learning process.

There is yet a further need in the art to students with a multi-modal instruction system which permits them to control the pace of learning and the complexity level of instruction received.

### SUMMARY OF THE INVENTION

The subject invention resolves the above-described needs and problems by providing a computer-based instruction system which utilizes a multi-modal teaching methodology and allows a student to select a preferred teaching technique, to control the pace and depth of learning, and to switch among the available teaching techniques at any point during the course of instruction.

The system consists of a central database of interrelated facts and principles (a “Learning Module” or “LM”) stored on CD ROM or in an Internet accessible computer server. An LM contains all of the facts and principles which form part of the curriculum to be taught to a student for a particular course subject. Users of the system access a particular course through their personal computer accessing the LM on CD ROM or via a portal to a website which presents the different courses available as well as the different learning methodologies, or “tracks”, by which the student may learn the materials.

LMs are organized into knowledge bases using a hierarchical “tree” model in which the course subject matter is divided into chapters, each chapter is divided into sections, each section is divided into headings and so forth. At each successively deeper level in the hierarchy, the complexity, detail and depth of the subject matter taught is increased. The administrator of the system incorporates into the LM, particular milestones which must be achieved by students in order to receive credit for the segment of the LM controlled by the milestone.

A milestone can be achieved by a student in a number of different ways depending on the learning methodology chosen. For example, a student who selects a “self-testing” teaching track may achieve a milestone in an LM by correctly answering a certain number of questions on the subject matter covered by the milestone.

By selecting the location of a milestone along the knowledge base hierarchy, the administrator of the system can select the level of complexity of the material which a student will be required to master in order to receive credit for the milestone. By setting the quantitative criteria which a student must achieve for a particular milestone (i.e., the number of correct responses needed to pass using a “self-testing” track), the administrator can select the level of proficiency, independent of the complexity level, which a student must have for a particular subject matter.

The system includes a mechanism which keeps constant track of the milestones which have been achieved by the student and milestones yet to be achieved. After a student has completed a particular milestone, the system presents the student with a choice of whether to continue with the remainder of the LM using the same teaching methodology previously selected or to continue using a different teaching methodology.

By permitting the student to change methodology after the completion of each milestone, the system allows the student to use the methodology which better suits him or her for the subject matter at hand. If a student changes his or her mind about the methodology chosen, the student can simply re-start the milestone using a different methodology. In this fashion, the system of the present invention allows a student to complete a LM using any combination of teaching methodologies available for the subject matter.

Administrators can also measure and record student participation, through automatic tracking and recording of numbers (quantity) of, complexities (quality) of, and time spent at specific elements of a LM by each user.

The milestones established by administrators are only the minimum requirements necessary to receive credit for the subject matter covered. The system allows students to optionally delve deeper into the subject matter than required by a particular milestone. Depending on the preference of the system's administrator, a student may receive extra-credit for learning subject matter which is more complex than that required. Alternatively, a student who deems itself capable of a higher level of learning may simply choose to delve deeper to gain a better understanding of the subject matter. Under either scenario, the system of the present invention permits the student to control the complexity of learning, beyond that minimally required, to be achieved in a particular subject.

Depending on the exigencies of a particular subject matter, the system administrator may require that all or some of an LM's milestones be completed in a particular sequence. When sequence is not important, milestones may be completed in the order preferred by the student. This feature gives the student exceptional control over the pace, as well as the preferred sequence, of learning.

In order to provide the above-mentioned features, the system of the present invention is composed of discrete but interrelated software modules. Among the modules provided are: student registration module, core subject matter authoring module, case study authoring module, question and answer authoring module, student home page generation module, grading/passing/certification module, and course administration module.

Disclosed herein is a system for providing to at least one student by at least one administrator a computer-based multi-modal instruction course, comprising: a registration software module; a content creation software module; an instruction software module; an administration software module; a core instruction database; an administration database; a communications server; a student computer workstation; and an administration computer workstation; wherein the administration database and core instruction database are accessible by and in communication with the student computer workstation and the administration computer workstation through the communications server; wherein the at least one student may become enrolled in the system by inputting information into the administration database by means of the student computer workstation, the registration software module and the communications server; wherein the at least one administrator may create at least one multi-modal instruction course by inputting information into the core instruction database by means of the administrator computer workstation, the content creation software module and the communications server; wherein the at least one multi-modal instruction course is comprised of a plurality of instruction tracks; wherein the at least one student may access the at least one multi-modal instruction course, may select and re-select as desired an instruction track from amongst the plurality of instruction tracks, and may learn the at least one multi-modal instruction course, by means of the student computer workstation, the instruction software module and the communications server; and wherein the at least one administrator may assess the level of learning of the at least one multi-modal instruction course achieved by the at least one student, by means of the administrator computer workstation, the administration software module and the communications server.

Accordingly, it is an object of the present invention to provide a computer-based instruction system to permit students, teachers and administrators to easily and seamlessly utilize multiple modes of instruction to teach a particular subject.

It is an additional object of the present invention to provide teachers and educational administrators with a system which permits the orderly and systematic management of multi-modal curricula.

It is an additional object of the present invention to provide teachers and educational administrators with a system which permits the coherent authoring of teaching materials for use in a multi-modal teaching environment.

It is an additional object of the present invention to provide teachers and educational administrators with a system which can measure the progress of a large number of student's each potentially using differing combinations of learning methodologies and learning paces.

It is an additional object of the present invention to provide students with a system which allows the selection of one, from amongst many, teaching methodologies, for learning a particular subject.

It is an additional object of the present invention to provide students with a system which enables them, once they have begun learning, to switch with ease between the multiple teaching methodologies without requiring restarting of the learning process.

It is an additional object of the present invention to provide students with a multi-modal instruction system which permits them to control the pace of learning and the complexity level of instruction received.

These and other objects, features, and advantages of the present invention may be more clearly understood and appreciated from a review of ensuing detailed description of the preferred and alternate embodiments and by reference to the accompanying drawings and claims.

### BRIEF DESCRIPTION OF THE DRAWINGS

FIG. 1 is a schematic block diagram which shows the interrelationship between different hardware and software components of the system.

FIG. 2 shows an example of the graphical user interface for the registration module of the present invention.

FIGS. 3A-3J show the graphical user interface for the administration and content creation modules of the present invention.

FIG. 4 shows an example of the graphical user interface for the instruction module of the present invention.

### DETAILED DESCRIPTION OF THE PREFERRED EMBODIMENT

Definitions—Actors

Direct Participant (“DP”): Primary actor in the system who takes the role of the student trained and tested through the system.

Administrator: Actor who monitors all the activities on the system and has responsibility for its overall management. Role is equivalent to a school administrator. The system of the present invention incorporates administrators of various types each having defined responsibilities within the educational process and a commensurate level of access to the various modules of the system.

External Intermediary (“EI”): Type of Administrator who is responsible for the instruction of individual DPs or a PG. Role is equivalent to a teacher.

Visitor: Individual whose role is identical to a DP except he or she cannot be certified as having completed a course until enrollment requirements are met.

Definitions—Terminology

Multi-Modal: Multiple/different modes, forms or approaches to the same target or goal.

Knowledge Tracks: Different learning pathways/routes that lead to a common set of related facts and principles (Learning Modules).

Learning Modules (“LM”): Sets of inter-related facts and principles.

My Tutor (MT): Module which determines areas of deficiency and allows DPs to constantly retest themselves in those areas.

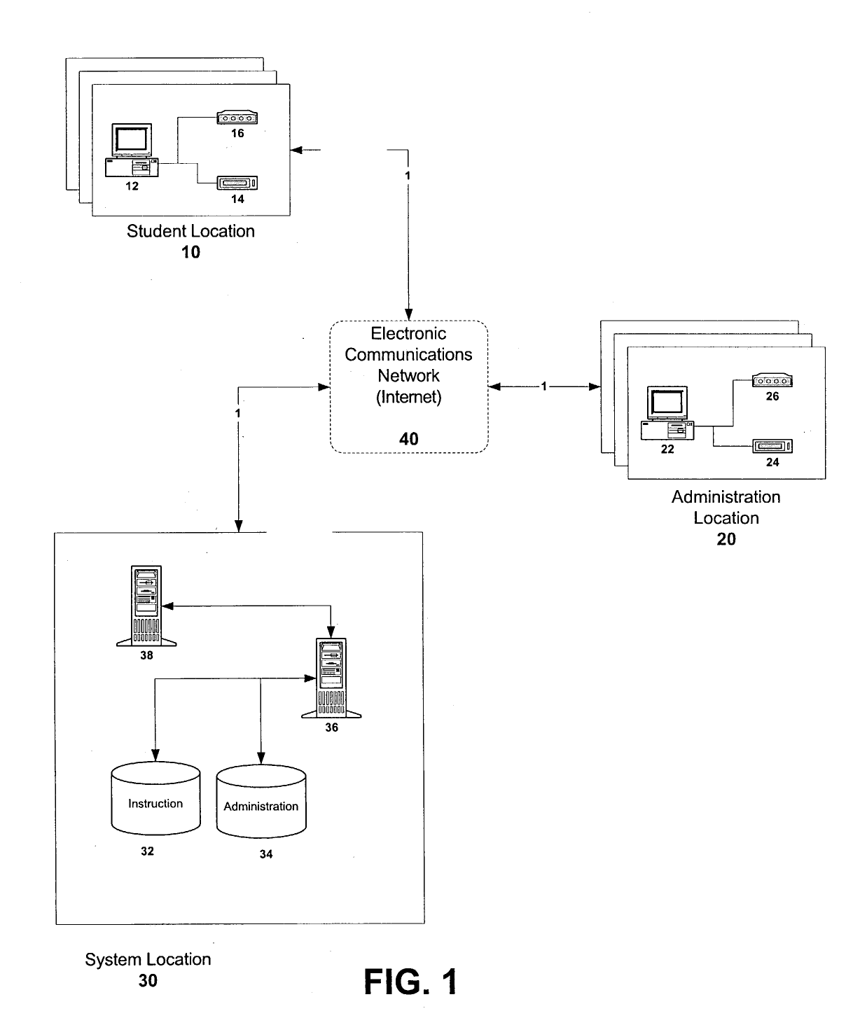

Referring initially to FIG. 1 of the drawings, in which like numerals indicate like elements throughout the several figures, the environment in a preferred embodiment of the present invention includes at least one Student Location 10, at least one Administration Location 20 and at least one System Location 30. It is envisioned at present that each of the three aforementioned locations will be housed in a separate physical building, however, a separate geographic presence for each location is not necessary for the present invention to function.

A Student Location 10 can be physically located anywhere a student, or DP, or a Visitor has access to a computer and the computer is capable of external communications or playing a CD ROM. At each Student Location 10 the DP or Visitor has access to a general purpose computer 12 such as an IBM-compatible personal computer (IBM PC) which, in turn, is equipped with a CD ROM drive and/or with telecommunications hardware 16, such as a modem or network adapter, and software capable of transmitting and receiving communications 14, such as a web browser. Each Student Location 10 may communicate with the System Location 30 and the Administration Location 20 through an electronic communications network 40, such as the Internet, through electronic communications means 1 which are well known in the art.

In the preferred embodiment of the subject invention, communications between the Student Location 10 the System Location 30 and the Administration Location 20 is carried out through the Internet via a world wide web browser such as Microsoft Internet Explorer, Netscape Navigator, or any other compatible web browser. In one alternative embodiment of the present invention, network communications may be handled through any one of a number of applications capable of communicating over protocols applicable to local area networks (“LANs”) or wide area networks (“WANs).

Similarly, an Administration Location 20 can be physically located anywhere an Administrator has access to a computer and the computer is capable of external communications. At each Administrator Location 20 the Administrator has access to a general purpose computer 22 such as an IBM-compatible personal computer (IBM PC) which, in turn, is equipped with telecommunications hardware 26, such as a modem or network adapter, and software capable of transmitting and receiving communications 24, such as a web browser. Each Administrator Location 20 can communicate with the System Location 30 and the Student Location 10 through an electronic communications network 40, such as the Internet, through electronic communications means 1 which are well known in the art. In the preferred embodiment of the subject invention, communications between the Administrator Location 20 the System Location 30 and the Student Location 10 is carried out through the Internet via a world wide web browser such as Microsoft Internet Explorer, Netscape Navigator, or any other compatible web browser. In an alternative embodiment of the present invention, network communications may be handled through any one of a number of applications capable of communicating over protocols applicable to local area networks (“LANs”) or wide area networks (“WANs).

All of the data processing functions of the system of the present invention take place at the System Location 30. The System Location 30 houses one or more networked computer servers which act as the interface between DPs, Visitors or Administrators and the core instruction and administration data which is contained in a plurality of computerized databases. The primary server at the System Location 30 is a web server 38 which has access to the same electronics communication network 40 accessible from the Student Location 10 and the Administrator Location 20. The primary function of the web server is to display information on, and accept input from, the DP, Visitor and Administrator's computers 12, 22.

In the preferred embodiment of the present invention, information is provided to the DPs, Visitors or Administrators as standard web pages formatted in hypertext markup language (“HTML”), extendible markup language (“XML”) or any other suitable Internet-compatible protocol. In the preferred embodiment of the present invention, the web server 38 consists of an IBM-compatible computer running Microsoft Internet Information Server (“IIS”) software or alternatively, a computer running Apache web server software on a variant of the UNIX operating system.

Requests for information are received by the web server 38 formatted as HTML or XML through the electronics communication network 40 by way of electronic communications means 1. The information requests are the passed on through an internal network such as a LAN or a WAN to a database interface server 36. The database interface server translates the HTML or XML requests into standard database queries which can then be used to fetch information from the core instruction and administration databases 32, 34. Once the information is received from the databases 32, 34 the database interface server assembles such information into HTML or XML pages and is passed on to the web server 38 which routes it back for display on the DP, Visitor or Administrator's computers 12, 22.

In the preferred embodiment of the present invention, the database interface server 36 consists of an IBM-compatible computer running Microsoft Active Server Page (“ASP”) software, Common Gateway Interface (“CGI”) software or other web enabled database connectivity software package. In the preferred embodiment of the present invention, the core instruction databases 32, 34 are formatted using a standard commercial database languages such as SQL, Access, and the like.

In an alternative embodiment of the present invention, one in which no network communication is available or selected, and the student's access is limited to CD ROM versions of the invention on its personal computer, the functions described for the administrator and facilitated through servers are provided through pre-set parameters contained within the CD ROM and based upon rules similar to those which have been set by the administrator—and disseminated through a server.

The present invention can be separated into a series of independent modules which together can handle all aspects of the disclosed system. The various modules include at least: (1) registration modules; (2) administration modules; (3) content creation modules; and (4) instruction modules.

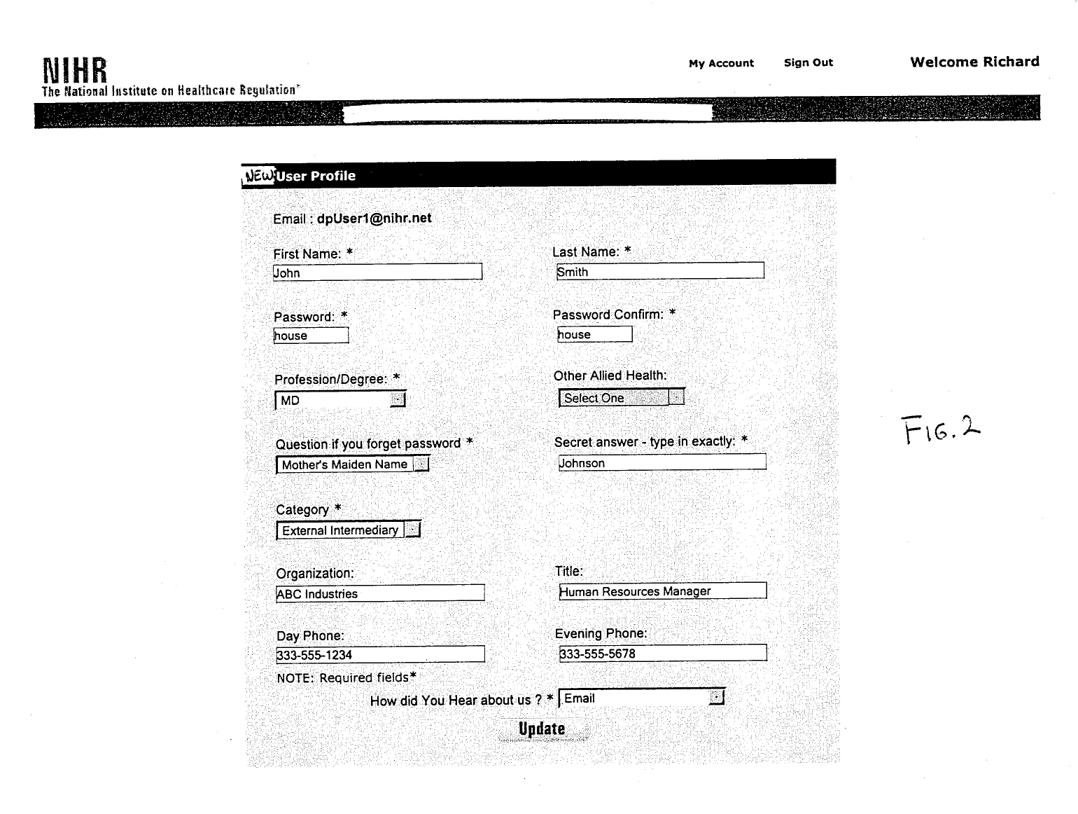

The registration modules are used to obtain and store demographic, payment and user verification information. With regard to DPs and Visitors, the registration modules are presented upon their initial access to the system when basic demographic data, such as name, address, e-mail address, is collected. The registration modules may also collect from DPs and Visitors extended information such as past academic achievements and school enrollment information. Additionally, the registration modules generate unique access identification information, such as a password and username which is assigned to each individual DP or Visitor so that they can identify themselves to the system during future sessions. FIG. 2 shows an example of the graphical user interface for the registration module of the present invention.

Administration modules serve as the interface through which the institution served by the Administrator, for example a school, can initially register with the system and enable computerized instruction on behalf of the institution. Administration modules, like registration modules, collect basic demographic data from the Administrator and also generate unique access identification information to enable secured access to the system in future sessions. Additionally, administration modules collect data from Administrators relating to the type of courses to be offered through the system by their respective institutions, the cost and availability of the courses, and other basic information related to the basic administration of courses to be offered through the system.

Finally, administration modules also permit Administrators to designate other individuals to act as External Intermediaries (“EI”) for particular courses to be offered through the system. EIs take the role of teachers for particular courses and have functions such as the creation of curriculum materials, core instruction materials and tests. EIs, in turn, are also responsible for the grading of tests and for establishing minimum requirements for certification for each test. All of the functions of the EI are accomplished through the administration modules. Data obtained through the Administration modules is stored in the administration database 32.

The content creation module is the tool used by Administrators and/or EIs to create curriculum materials used for the instruction of the DPs. On of the critical elements of the present invention is that instruction of the DPs is multi-modal. That is, that a variety of teaching methods is used to teach the curriculum materials to the DPs and the DPs can select the teaching technique they prefer at any time. Accordingly, curriculum materials for a particular course have to be completely re-created in each of the available teaching techniques, or “Knowledge Tracks.” The content creation modules make available to the EI or Administrator responsible for creation of curriculum materials, specialized tools for the creation of teaching materials in each available Knowledge Track. Data entered through the content creation modules is stored in the core materials database 34.

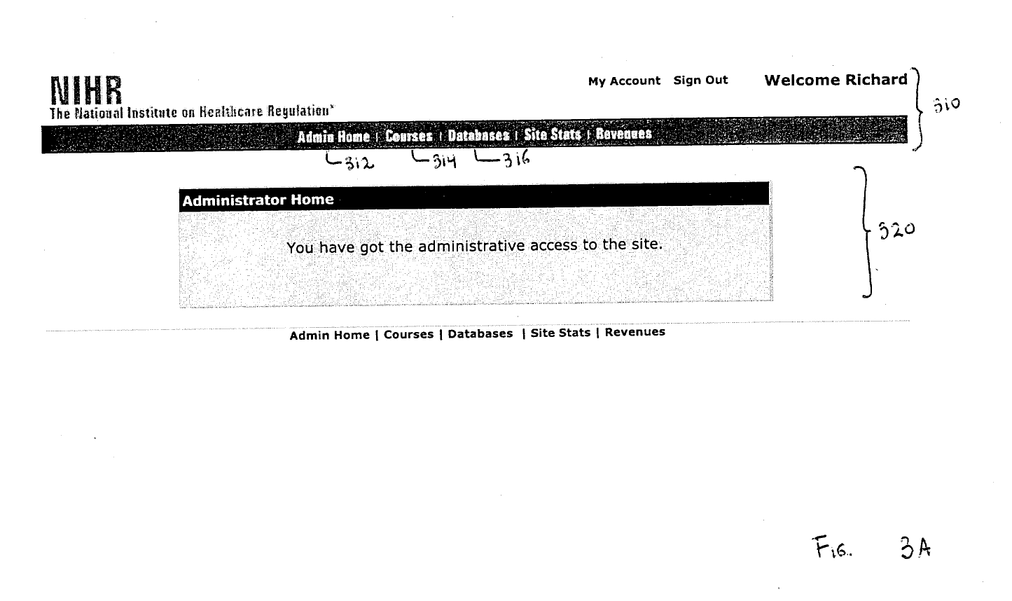

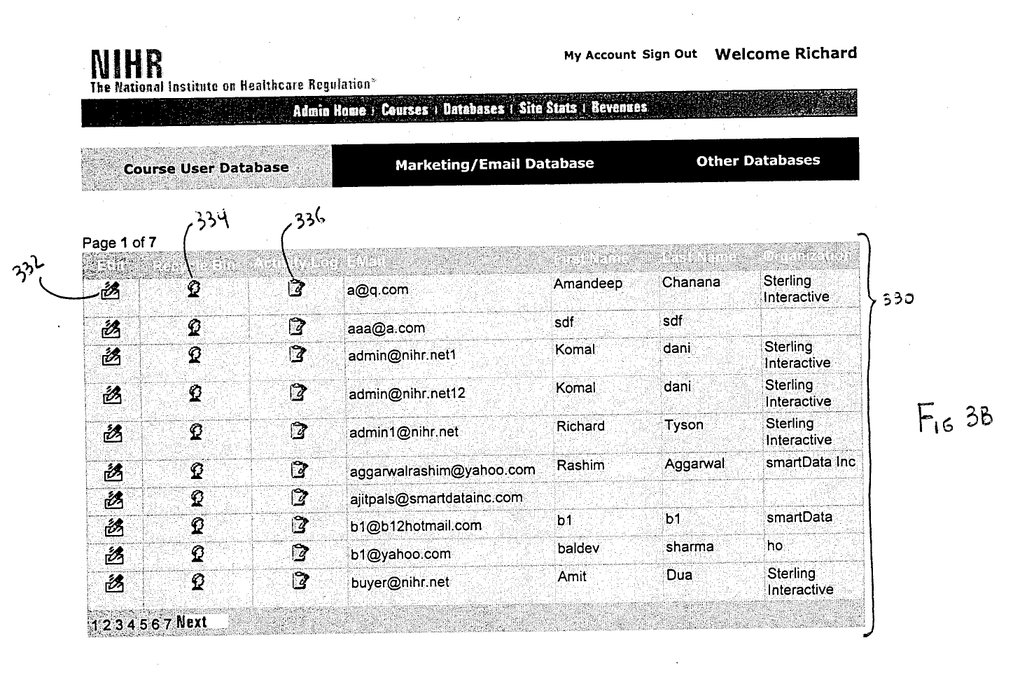

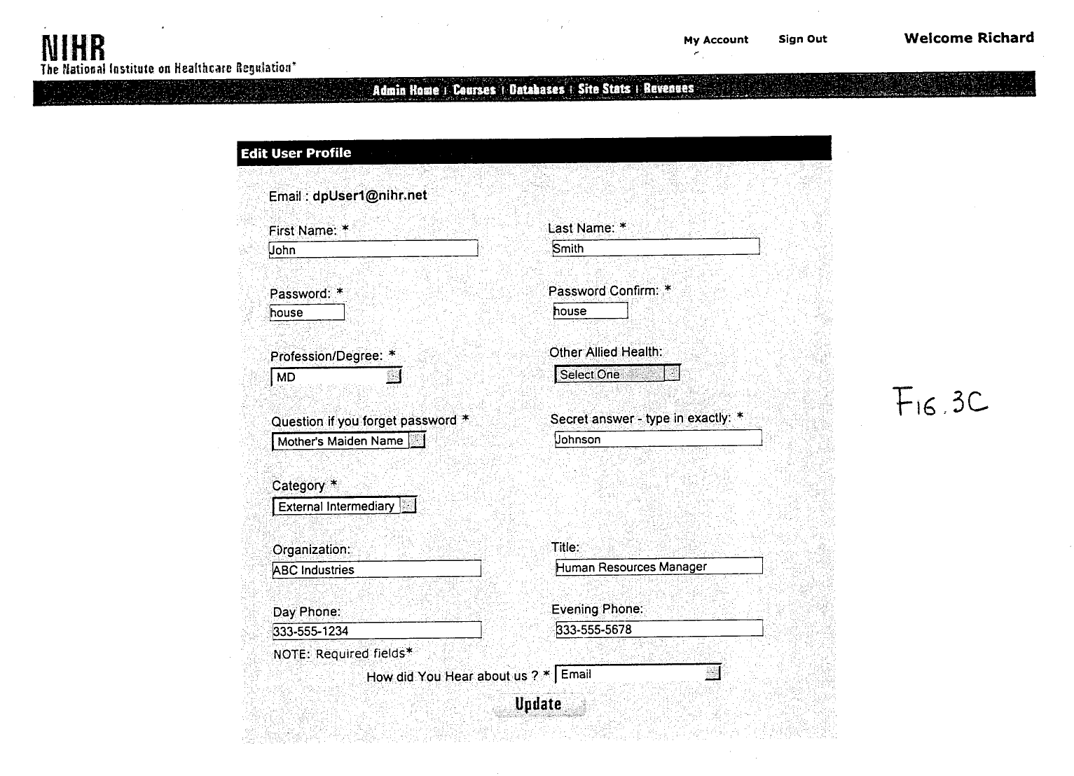

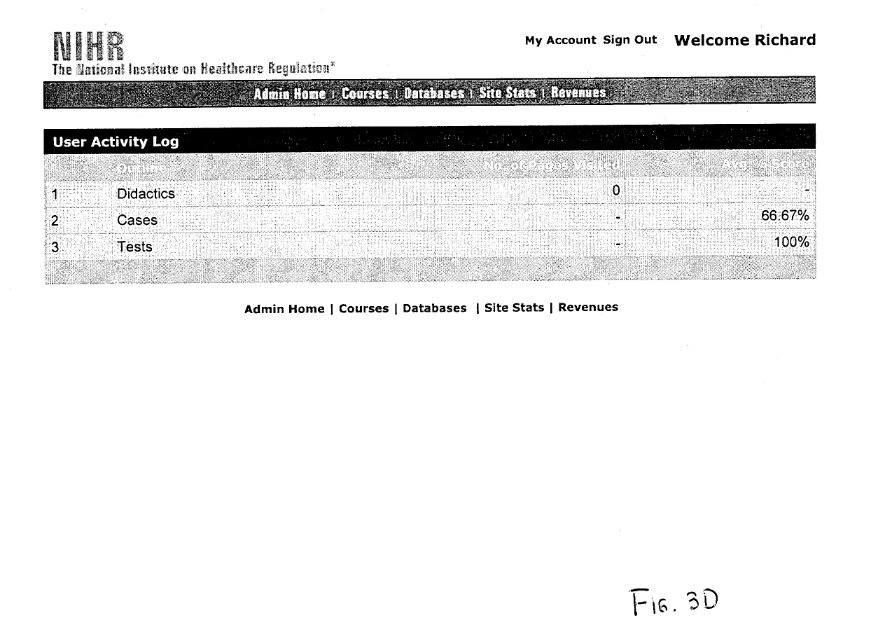

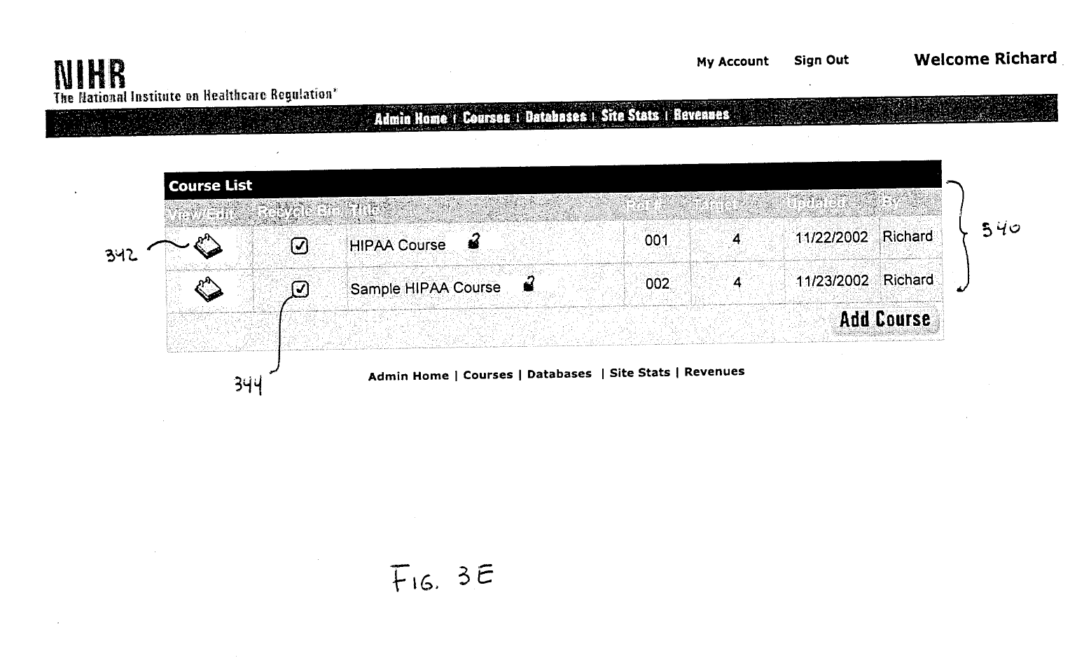

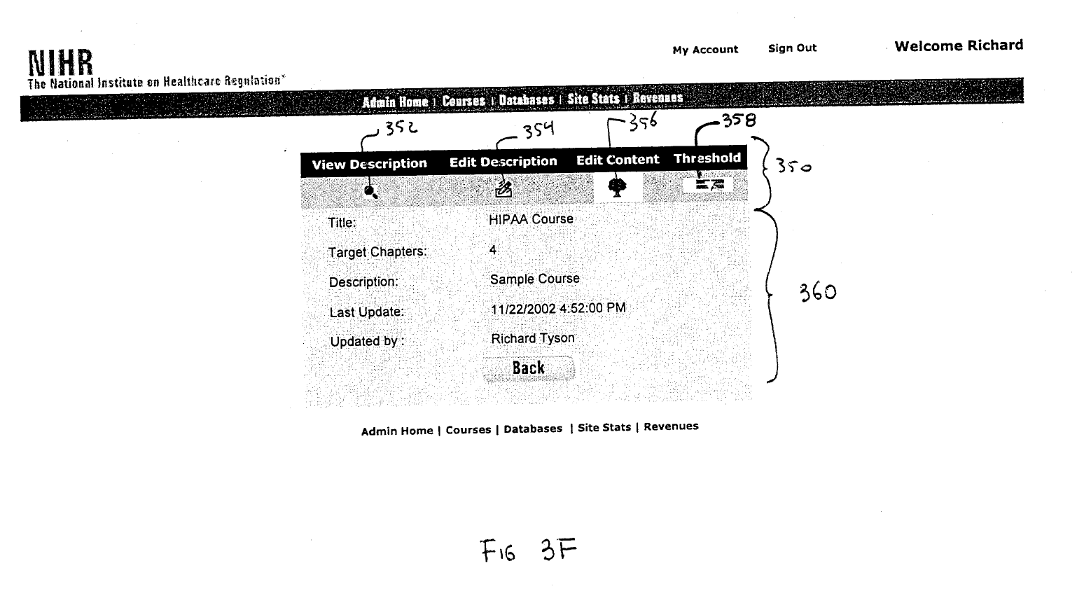

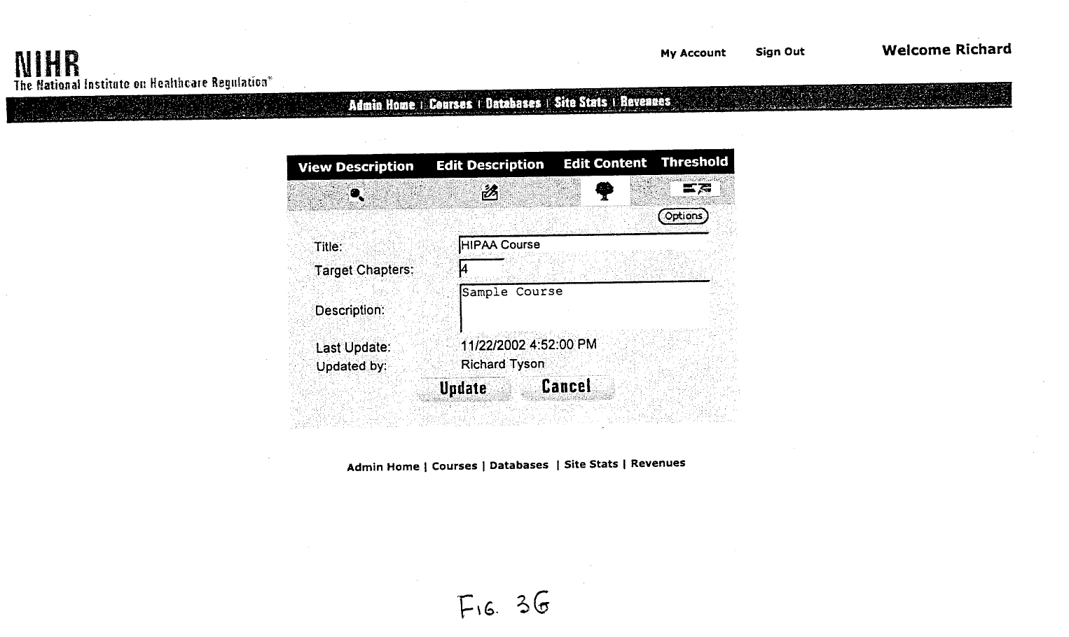

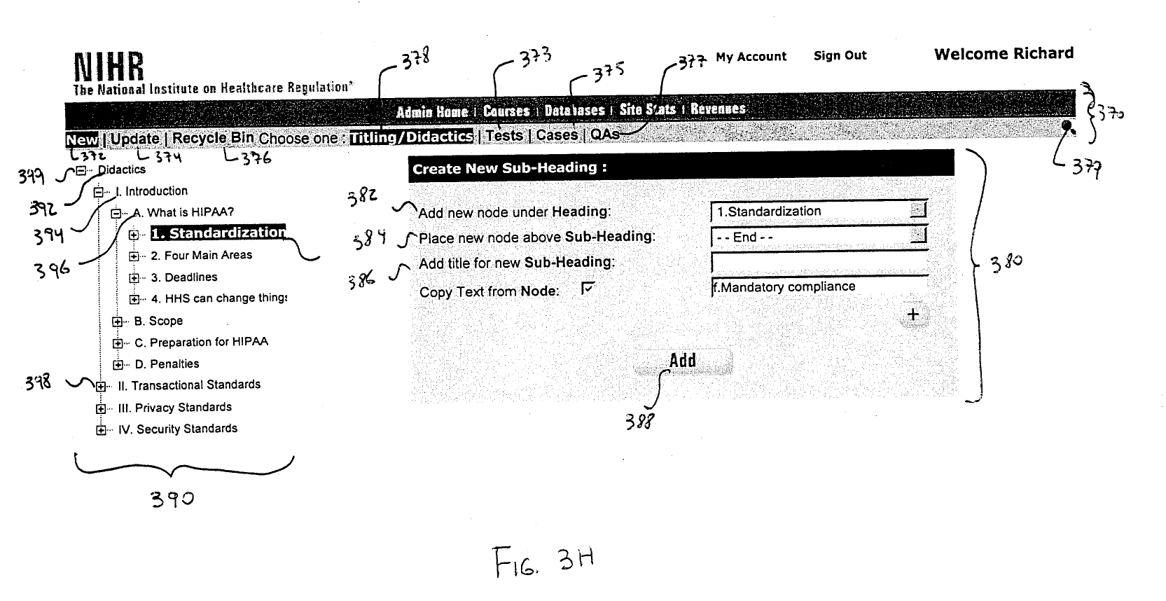

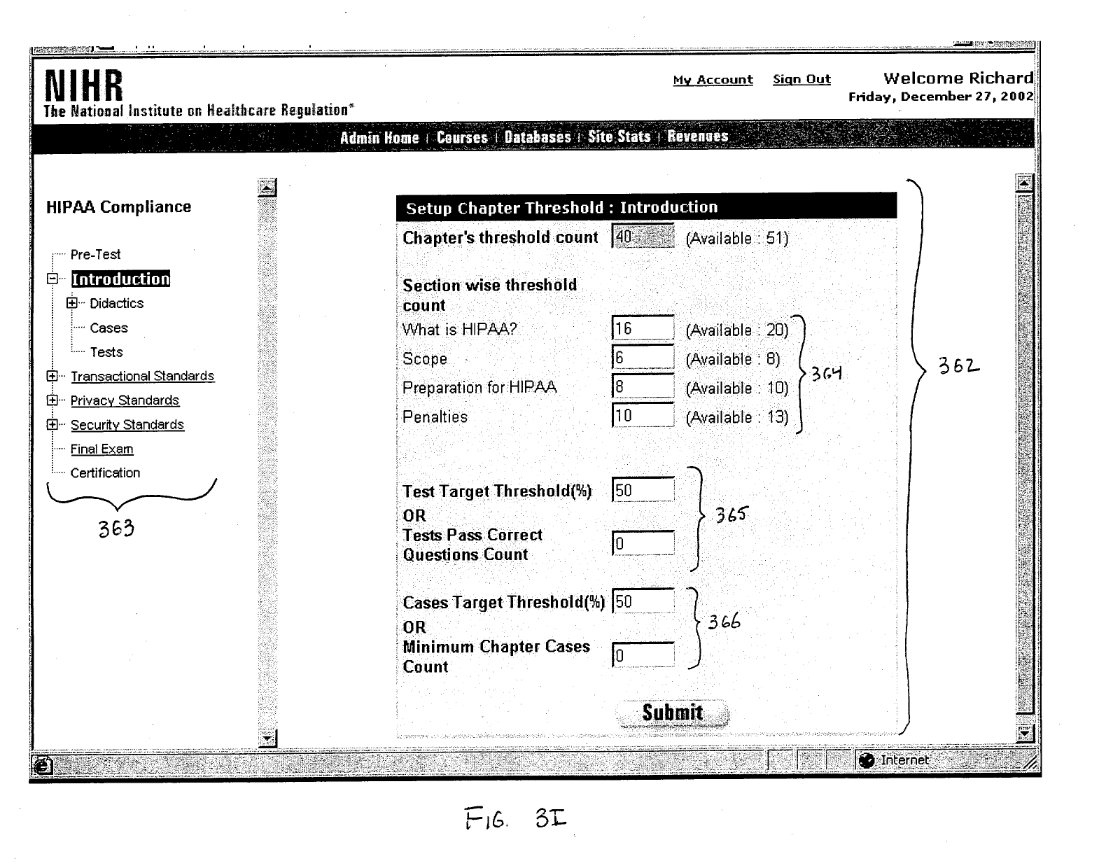

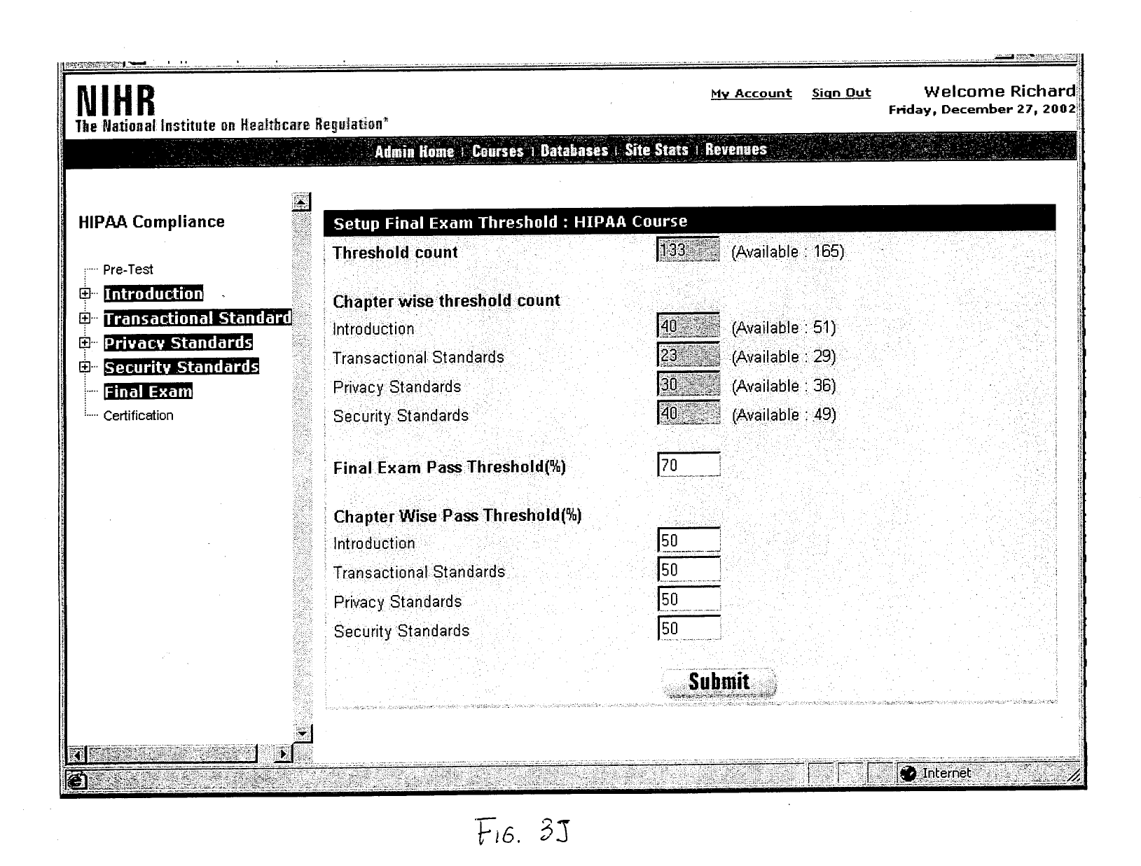

FIGS. 3A-3J show an example of the graphical user interface for the administration and content creation module of the present invention.

After logging in with a valid administrative access username and password, the user is presented with the main administrator page, also referred to as the “Administrator Home” page, shown in FIG. 3A. The Administrator Home page, and every page it links to, is divided into two sections: the menu section 310 and the data display and input section 320. The menu section 310, which is repeated throughout the various screens of the administration and content creation modules, contains links for the various functions available from these modules, including return to the Administrative Home page 312, course content creation and editing 314 and course participant's database maintenance 316.

Upon selection of the course participant's database maintenance link 316, the user is presented with the Course User Database Administration page shown in FIG. 3B. This page is course specific and displays a list of all registered users that are associated with the presently selected course. The data display and input section 330 for the Database Administration page contains a table with information regarding each registered user. For each user there are edit 332 delete 334 and activity log 336 buttons.

Selecting the edit button 332 causes the Edit User Profile page to display as shown in FIG. 3C. From this page, the administrator can change basic information about the user including the name, password, demographical information, type of participant (i.e., DP, EI or Visitor) and contact information. Selecting the delete button 334 removes the selected user record from the course. Selecting the activity log button 336 causes the User Activity Log page to display as shown in FIG. 3D. The User Activity Log page displays information regarding the user's course-related activities such as the number of pages visited and average test scores.

Returning now to the Administrator Home page (FIG. 3A) upon selection of the course content creation and editing link 314, the user is presented with the Course List page shown in FIG. 3E. This page displays a list of all courses to which the user has administrative privileges to edit content. The data display and input section 340 for the Course List page contains a table with basic identifying information regarding each course. For each course there are edit 342 and delete 344 buttons.

Selecting the delete button 344 deletes the selected course from the course database 32. Selecting the edit button 342 causes the Course Content Editing home page to display as shown in FIG. 3F. From this page, the administrator can review and edit the actual instructional content for the selected course. The Course Content Editing home page has its own menu section 350 which contains links for the course editing functions as well as a data display and input section 360 which displays course description information such as the course name, number of chapters, subject matter description, last update date, and the name of the user who last updated the course content.

The choices available in the Course Content Editing home page menu section 350 include links to return to the Course Content Editing home page 352, to edit the course description 354, to actually edit the course content 356 and to edit the thresholds, or learning milestones required to attain a “passing” score, for each portion of the course 358. Selecting the link to edit the course description 354, causes the Course Description Editing page to display as shown on FIG. 3G. This screen allows the user to input the relevant course description information and save it to the course database 32.

Selecting the link to edit the course content 356, causes the Course Content Editing page to display as shown on FIG. 3H. The Course Content Editing page is divided into three sections. The menu section 370 located at the top edge of the screen, the outline section 390 located directly beneath the menu section 370 and on the left portion of the screen, and the content input section 380, also located directly beneath the menu section 370 but occupying the right portion of the screen. The choices available at the menu section 370 include links to create new content 372, to update existing content 374, and to delete already entered content 376. The menu section 370 also contains links to allow for entry of content for each Knowledge Track implemented through the system. In the preferred embodiment of the present invention, the available Knowledge Tracks include didactics 378, tests 373, and case studies 375. In addition, with regard to all Knowledge Tracks, the user may create questions and answers and associate them with relevant sections of the course outline. The entry of questions and answers is facilitated by another link 377 on the menu section 370.

The outline section 390 of the Course Content Editing page, allows the user to navigate through the course outline to the point where new content is to be inserted or where existing content is to be edited or deleted. The outline section 390 displays an expandable “tree” view of an outline for the teaching materials of the course being taught by the system. The outline is a hierarchical ordering of topics for the course materials. In the preferred embodiment, the instructional materials are broadly divided into chapters 392, each chapter is divided into sections 394, and each section is divided into headings 396. By clicking on the expansion symbol 398 (generally a plus ((+)) symbol) positioned adjacent to each level of the outline, the level is expanded to display all sublevels nested beneath it in the hierarchy. Similarly, by clicking on the contraction symbol 399 (generally a minus (−) symbol) positioned adjacent to each level of the outline, the level is contracted and all sublevels nested beneath it in the hierarchy are hidden from view.

As the user navigates through the outline section 390 the text in the content input section 380 changes to reflect the present location in the outline in a dedicated field 382. The user can then select where, in reference to the present location on the outline (i.e. before the currently selected chapter, section or heading) new content is to be inserted 384 as well as the title for the new content's heading 386. When this initial information has been entered, the user can the select the “Add” button 388 and will be displayed a screen where the new content can be inputted. Finally, if the user wishes to “preview” newly entered or edited content, he or she can select the preview button 379 which is located in the menu section 370.

Returning now to the Course Content Editing home page (FIG. 3F) upon selection of the threshold editing link 358, the Threshold Editing Screen is displayed as shown in FIG. 31. The Threshold Editing Screen has the same 3-part organization as the Course Content Editing page (FIG. 3H) except that the input section 362 displays the minimum thresholds that must be achieved for each chapter selected from the outline section 363. In the preferred embodiment, three different threshold types are specified. The first threshold, the page views threshold, is the minimum number of core material screens for each chapter that must be viewed by the user. The page views threshold can be entered as shown at 364. The second threshold, the chapter test threshold, is the minimum number or percentage of correct responses that must be attained for each test corresponding to the subject chapter. The chapter test threshold can be entered as shown at 365. The third threshold, the chapter case studies threshold, is the minimum number or percentage of correct responses that must be attained for each case study corresponding to the subject chapter. The chapter case studies threshold can be entered as shown at 366.

Collective thresholds and final exam thresholds can be entered by selecting the final exam item on the outline section 363 which will result in display of the Final Exam threshold entry screen in the input section 362. FIG. 3J is an example of the Threshold Editing Screen with the Final Exam threshold entry screen displayed in the input section 362.

The preferred embodiment of the present invention incorporates at least three independent Knowledge Tracks. The three Knowledge Tracks are referred to as Didactics, Self-Testing and Case Studies. The Didactics Knowledge Track consists of the traditional core reference materials in a form very similar to a conventional textbook. The Self-Testing Knowledge Track consists entirely of a series of tests in a format, such as multiple choice, suitable for grading without human intervention. The Case Studies Knowledge Track consists of a series of fact patterns, generally modeled after real world situations related to the subject matter of the course, followed by a series of questions, the answers to which, similarly to those in the Self-Testing Knowledge Track, can be graded without human intervention. A complete set of Knowledge Tracks for a particular subject is the equivalent of a complete course curriculum in a traditional environment and is commonly referred to as a Learning Module (or “LM”) in the preferred embodiment of the present invention.

In addition to Knowledge Tracks, the preferred embodiment also incorporates the concept of instruction Pathways. Whereas a Knowledge Track can comprises the entire set of instruction materials necessary to teach a subject using as single teaching methodology, a Pathway is a combination of two or more Knowledge Tracks into a coherent and comprehensive teaching curriculum for the subject. That is, a Pathway is a set of elements taken from each Knowledge Track which can be combined to form a customized instruction curriculum utilizing the strengths of each Knowledge Track and applying them to course material that benefit from them the most. An EI can create “Suggested” Pathways for a particular course and store them in the system so that they are available to DPs and Visitors. Alternatively, each DP or Visitor can create his or her own customized “Self-Directed” Pathway based on their teaching methodology preferences for the respective course materials. In addition, a Suggested Pathway may also be created by the system “on-the-fly” if the DP or Visitor elects to take a pre-test prior to beginning instruction on a particular course or subject. The Suggested Pathway that is created using the pre-test is designed to emphasize and reinforce teaching on areas of deficiency and to de-emphasize areas which the DP or Visitor already has solid knowledge.

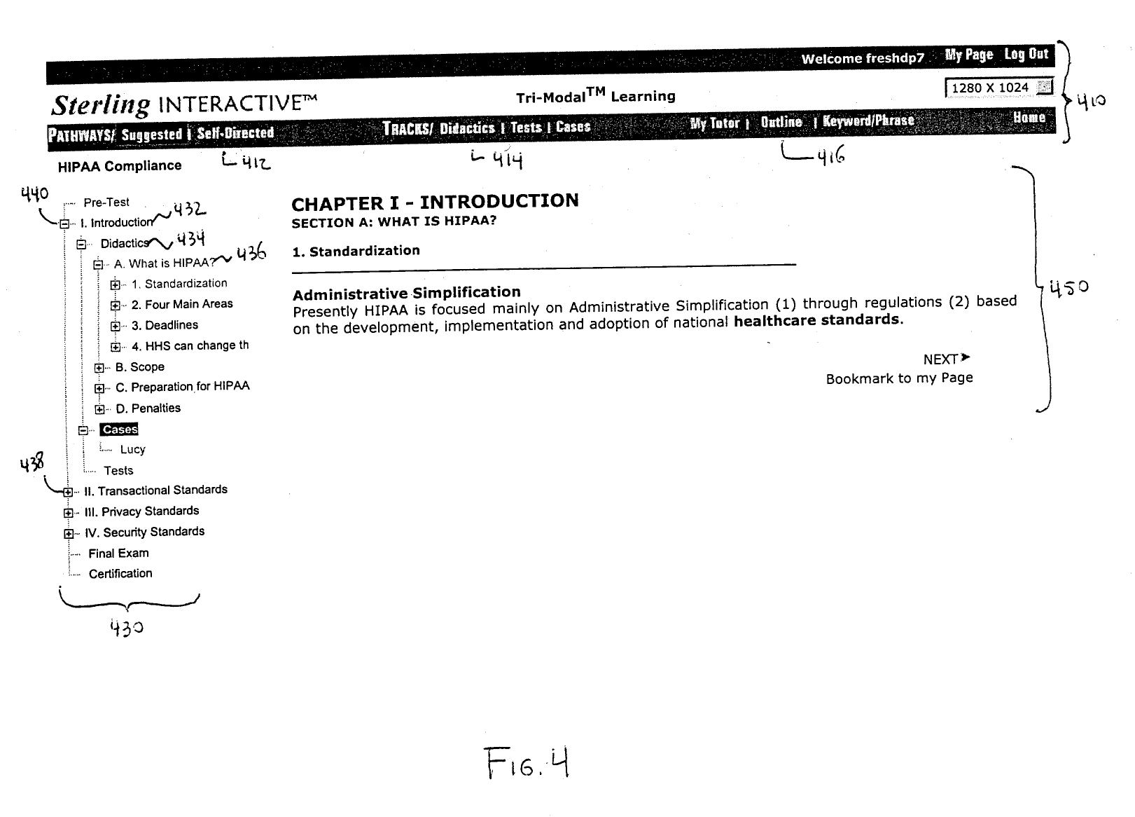

The instruction modules of the present invention provide the user interface whereby instruction is delivered by the system to the DPs and Visitors. DPs and Visitors would generally only be able to access the instruction modules after they have been duly registered, complied with all eligibility requirements for receiving instruction in a particular course and, unless the course is available for free, have paid for their tuition. FIG. 4 shows an example of the graphical user interface for an instruction module of the present invention.

The instruction module interface screen is divided into three sections. The menu section 410 located at the top edge of the screen, the outline section 430 located directly beneath the menu section 410 and on the left portion of the screen, and the instruction section 450, also located directly beneath the menu section 410 but occupying the right portion of the screen. All of the screens presented to the DP or Visitor in the preferred embodiment of the present invention are formatted as web pages (whether accessed via the Internet or through a self-contained CD ROM in the DP's or Visitor's computer).

The menu section 410 provides three separate clusters of choices. The leftmost cluster 412 provides for the selection of the current Pathway. Choices include one or more Suggested Pathways and one or more Self-Directed Pathways. The middle cluster 414 provides for the selection of the current Knowledge Track. A choice is provided for each Knowledge Track available for the currently selected course. The rightmost cluster 416 provides for the selection of miscellaneous tools available to the DP or Visitor depending on the course being taken and the level of use permitted by the Administrator and/or EI. Choices in the rightmost cluster include, keyword searches of the materials, selection of a “home” page, and a selection of tools for determining areas of deficiency, collectively referred to as the My Tutor module. The choices are presented to the user as hyperlinks which can be selected by positioning a cursor or pointer over each choice using an input device such as a mouse or keyboard and pressing the selection button, an action commonly referred to as “clicking” on a link. A DP or Visitor is generally able to make choices from the menu section 410 at any time during the instruction session.

The outline section 430 of the instruction module displays an expandable “tree” view of an outline for the teaching materials of the course being taught by the system. The outline is a hierarchical ordering of topics for the course materials. In the preferred embodiment, the instructional materials are broadly divided into chapters 432, each chapter is divided into sections 434, and each section is divided into headings 436. By clicking on the expansion symbol 438 (generally a plus ((+)) symbol) positioned adjacent to each level of the outline, the level is expanded to display all sublevels nested beneath it in the hierarchy. Similarly, by clicking on the contraction symbol 440 (generally a minus (−) symbol) positioned adjacent to each level of the outline, the level is contracted and all sublevels nested beneath it in the hierarchy are hidden from view.

The contents of the outline will vary depending on the currently selected Pathway or Knowledge Track. In addition, sections of the outline may be available for expansion or review (i.e., “unlocked”), only after a particular milestone, generally achieving a minimum passing score on a test of prerequisite materials, has been achieved. The levels of the outline can be color-coded, or otherwise highlighted to denote the status of each level. For example, “locked” levels of the outline may be colored in red, unlocked and “passed” sections of the outline may be highlighted in green, and unlocked but not yet “passed” sections of the outline may be highlighted in yellow.

The instruction section 450 of the instruction module, as its name implies, displays the actual instruction materials from which the DPs and Visitors are expected to learn the course curriculum. The contents of the instruction section will change whenever a new level is selected in the outline section 430 and will relate to the title of the selected level. The type of materials displayed on the instruction section 550 will vary depending on the currently selected Knowledge Track or Pathway. For example, if a Self-Testing Knowledge Track is selected, the instruction section 450 will display questions, answers, and explanations for the answers. If the Didactics Knowledge Track is selected, the instruction section 450 will display core reference materials in textbook form.

During a typical study lesson, a DP or Visitor would begin by accessing a portal page for the web server housing the system and would proceed to log in using a pre-assigned user ID and password. It is assumed that the DP or Visitor has previously registered for and paid for a course available through the system.

Upon login, the system would display to the DP of Visitor a list of courses he or she is presently enrolled in. The DP or Visitor would then select a course and begin the session. The DP or Visitor would first be shown the previously described instruction module main screen. From there the DP or Visitor can begin interacting with the system. If the DP or Visitor is returning after a previous session, the outline section of the screen would depict the course outline with the outline headings appropriately highlighted to show which course subjects have been completed. The DP or Visitor would then be able to select a subject which has not been completed and begin learning the subject using the Pathway or Knowledge Track of his choice. Alternatively, the DP or Visitor can select a previously “passed” subject to reinforce the knowledge learned or to simply explore the subject in more depth than is required to actually earn a passing grade.

In order to complete a particular subject, the student must take a test for the subject and earn a minimum passing grade. Depending on how the course has been set up by the Administrator or EI, the DP or Visitor may be required to review a minimum number of screens for the given subject, or take a certain number of mini-quizzes on the subject, before being allowed to take the test which would qualify the subject as “passed”. Upon completion of the subject test and achievement of a minimum score, the DP or Visitor is credited with having “passed” the subject and may continue with the next subject until completion of the entire course.

Although the preferred embodiment of the present invention anticipates that a DP or Visitor would be required to complete all of the subjects of the course in a pre-determined sequence, it is envisioned that the subject matter for certain courses would lend itself to a less structured approach which would allow the DP or Visitor to complete the subjects in a sequence of their preference.

Upon completion of all subjects for a given course, the DP or Visitor may be required to take a final examination for the course in order to receive a certificate of completion or a diploma. Alternatively, a course may be set up so that a final examination is not required and the certificate of completion or diploma is granted upon completion of all subjects, or a minimum subset of subjects, for the given course. The certificate of completion or diploma may be a digitally signed document to ensure its authenticity or may be printed and mailed to the DP or Visitor as evidence of completion of the course.

Additional tools which are available to a DP or Visitor while in the instruction module include the ability to create a customized “home page” which is accessible at all times from the rightmost cluster of the menu section. During the instruction session, the DP or Visitor can “bookmark” particular subjects or reference materials which he or she may want to review in the future. By bookmarking the desired subject matter, the DP or Visitor would be able to quickly review the desired materials without having to search for it in the course outline.

Another tool available to the DP or Visitor during the instruction session is the My Tutor (“MT”) module. The MT module can be used to determine areas where the knowledge of the DP or Visitor is deficient and to reinforce instruction in those areas. The MT module works by creating mini-tests which are customized by the DP or Visitor depending on their target subjects. The DP or Visitor can create a test dealing with particular subjects and can specify the number of questions included in the mini-test for each subject selected. Upon completion of the mini-test, the MT module provides a graded version of the examination with explanations as to why each available choice for a particular question is correct or incorrect. The MT module also provides links to additional reference materials, both within the course outline and from external sources. The MT module can keep track of all mini-tests taken by the DP or Visitor and can provide feedback to illustrate a progression of scores achieved for particular subjects. Finally, the MT module can automatically generate mini-tests for areas in which the DP or Visitor has historically shown a deficiency.

It will be understood by those skilled in the art that the disclosed computer-based system for instruction using multi-modal teaching methods may be practiced without regard to the relative timing of the interaction between the DP or Visitor and the EI. That is, the interaction between the DP or Visitor and the EI may occur in (a) while both actors are logged-on to the system simultaneously (i.e. synchronously) through real-time or near real-time communication methods; or (b) independent of the timing of the connection (i.e. asynchronously) through stored communications which may be accessed at any time by either actor.

It will be understood by those skilled in the art that although the preferred embodiment of the present invention utilizes the Internet as its primary electronic communications network, other types of computer networks may serve equally well for the intended purpose. Non-limiting examples of other types of networks which can function with the disclosed invention include: local area networks (LANs), wide area networks (WANs), peer-to-peer networks (P2P), wireless networks (WiFi) and hybrids and combinations thereof.

Accordingly, it will be understood that the preferred embodiment of the present invention has been disclosed by way of example and that other modifications and alterations may occur to those skilled in the art without departing from the scope and spirit of the appended claims.

We claim:

1. A system for providing to at least one student by at least one administrator a computer-based multi-modal instruction course, comprising:
a registration software module;
a content creation software module;
an instruction software module;
an administration software module;
a core instruction database;
an administration database;
a communications server;
a student computer workstation; and
an administration computer workstation;
wherein said administration database and core instruction database are accessible by and in communication with said student computer workstation and said administration computer workstation through said communications server;
wherein said at least one student may become enrolled in said system by inputting information into said administration database by means of said student computer workstation, said registration software module and said communications server;
wherein said at least one administrator may create at least one multi-modal instruction course by inputting information into said core instruction database by means of said administrator computer workstation, said content creation software module and said communications server;
wherein said at least one multi-modal instruction course is comprised of a plurality of instruction tracks;
wherein said at least one student may access said at least one multi-modal instruction course, may select and re-select as desired an instruction track from amongst said plurality of instruction tracks, and may learn said at least one multi-modal instruction course, by means of said student computer workstation, said instruction software module and said communications server; and
wherein said at least one administrator may assess the level of learning of said at least one multi-modal instruction course achieved by said at least one student, by means of said administrator computer workstation, said administration software module and said communications server.

2. The system of claim 1, wherein said communications between said administration database and said core instruction database and said student computer workstation and said administration computer workstation is done through a computer network.

3. The system of claim 2, wherein said computer network is selected form the group consisting of: the Internet, a wide area network, a local area network, a peer-to-peer network, a wireless network, and combinations thereof.

4. The system of claim 1, wherein said communications server is a web server.

5. The system of claim 4, wherein said registration software module, said content creation software module and said instruction software module are accessed by said at least one student and said at least one administration through a standard web browser.

6. The system of claim 1, wherein said communications between said administration database and said core instruction database and said student computer workstation and said administration computer workstation is synchronous.

7. The system of claim 1, wherein said communications between said administration database and said core instruction database and said student computer workstation and said administration computer workstation is asynchronous.

8. The system of claim 1, wherein said plurality of instruction tracks is selected from the group consisting of: a didactics track, a self testing track, and a case study track.

9. The system of claim 1, wherein said assessment by said at least one administrator of the level of learning of said at least one multi-modal instruction course achieved by said at least one student comprises determining whether learning thresholds have been achieved by said at least one student.

10. The system of claim 9 wherein said learning thresholds are selected form the group consisting of: page view thresholds, chapter test thresholds, chapter case study thresholds, and combinations thereof.

11. A system for providing to at least one student by at least one administrator a computer-based multi-modal instruction course, comprising:
a registration software module;
a content creation software module;
an instruction software module;
an administration software module;
a core instruction database;
an administration database;
a communications server;
a permanent storage medium;
a student computer workstation; and
an administration computer workstation;
wherein said administration database is accessible by and in communication with said student computer workstation and said administration computer workstation through said communications server;
wherein said core instruction database is stored in said permanent storage medium and is accessible from said student computer workstation;
wherein said at least one student may become enrolled in said system by inputting information into said administration database by means of said student computer workstation, said registration software module and said communications server;
wherein said at least one administrator may create and permanently store in said permanent storage medium at least one multi-modal instruction course by inputting information into said core instruction database by means of said administrator computer workstation and said content creation software module.
wherein said at least one multi-modal instruction course is comprised of a plurality of instruction tracks;
wherein said at least one student may access said at least one multi-modal instruction course, may select and re-select as desired an instruction track from amongst said plurality of instruction tracks, and may learn said at least one multi-modal instruction course, by means of said student computer workstation and said instruction software module; and
wherein said at least one administrator may assess the level of learning of said at least one multi-modal instruction course achieved by said at least one student, by means of said administrator computer workstation, said administration software module and said communications server.

12. The system of claim 11, wherein said communications between said administration database said student computer workstation and said administration computer workstation is done through a computer network.

13. The system of claim 12, wherein said computer network is selected form the group consisting of: the Internet, a wide area network, a local area network, a peer-to-peer network, a wireless network, and combinations thereof.

14. The system of claim 11, wherein said communications server is a web server.

15. The system of claim 14, wherein said registration software module is accessed by said at least one student through a standard web browser.

16. The system of claim 11, wherein said permanent storage medium is a CD-ROM.

17. The system of claim 11, wherein said plurality of instruction tracks is selected from the group consisting of: a didactics track, a self testing track and a case study track.

18. The system of claim 11, wherein said assessment by said at least one administrator of the level of learning of said at least one multi-modal instruction course achieved by said at least one student comprises determining whether learning thresholds have been achieved by said at least one student.

19. The system of claim 18 wherein said learning thresholds are selected form the group consisting of: page view thresholds, chapter test thresholds, chapter case study thresholds, and combinations thereof.

20. A method of instruction comprising:
at least one administrator; and
at least one student;
wherein said at least one administrator may create at least one multi-modal instruction course;
wherein said at least one multi-modal instruction course is comprised of a plurality of instruction tracks;
wherein said at least one student may access said at least one multi-modal instruction course, may select and re-select as desired an instruction track from amongst said plurality of instruction tracks, and may learn said at least one multi-modal instruction course; and
wherein said at least one administrator may assess the level of learning of said at least one multi-modal instruction course achieved by said at least one student.

21. The system of claim 20, wherein said plurality of instruction tracks is selected from the group consisting of: a didactics track, a self testing track and a case study track.

22. The system of claim 20, wherein said assessment by said at least one administrator of the level of learning of said at least one multi-modal instruction course achieved by said at least one student comprises determining whether learning thresholds have been achieved by said at least one student.
